(19) United States
(12) Patent Application Publication
(10) Pub. No.: US 2015/0130184 A1
(43) Pub. Date: May 14, 2015

(54) BARBED HOSE END FITTING APPARATUS FOR PTFE CORE HOSE

(71) Applicant: Larry A. Filipczak, West Bloomfield, MI (US)

(72) Inventor: Larry A. Filipczak, West Bloomfield, MI (US)

(73) Assignee: TECHAFX, INC., West Bloomfield, MI (US)

(21) Appl. No.: 14/539,360

(22) Filed: Nov. 12, 2014

Related U.S. Application Data
(60) Provisional application No. 61/902,850, filed on Nov. 12, 2013.

(51) Int. Cl. F16L 33/06

(52) U.S. Cl. CPC F16L 33/06
USPC 285/252

(57) ABSTRACT

A barbed hose end fitting apparatus for a PTFE core hose sealing couples a PTFE core hose to a fluid component. The fitting apparatus includes a fitting carrying a first barb for sealing insertion of one end of a PTFE hose forced over the first barb. An opposite end of the fitting includes threads to couple the fitting to another fluid component. A gripping surface formed of hex flats can be disposed intermediate between the ends of the body to facilitate coupling and uncoupling of the fitting to another component.

### CROSS REFERENCE TO CO-PENDING APPLICATION

This application claims priority benefit to the Nov. 12, 2013 filing date of co-pending U.S. Provisional Patent Application Ser. No. 61/902,850 for BARBED HOSE END FITTING FOR POLYTETRAFLUOROETHYLENE (PTFE) CORE HOSE, the entire contents of which are incorporated herein in its entirety.

### BACKGROUND

The present disclosure relates to the field of liquid transfer hose assemblies and, in particular, to barbed hose end fittings for use in combustible liquid fuel transfer systems.

There remains a problem in the prior art in that today's automotive fuel has become incompatible with commonly used hose assemblies consisting of black rubber fuel hose and existing barb fitting technology. Today's fuel degrades the rubber hose itself and/or results in fuel vapor constantly seeping through the rubber hose carcass. This results in a constant ‘fuel smell’ in many vehicles, and often is the precursor to catastrophic failure of the rubber hose after only a short time exposure to the fuel, which produces a dangerous liquid fuel leak.

The recent prior art solution to this problem is to use hose assemblies created from PTFE-core hose and fittings. The prior art liquid fuel invention fittings for PTFE-core hose are designed for late model, fuel injection inventions. These prior art high-pressure PTFE fittings are expensive, often require special knowledge and tools to properly install on PTFE-core hose, and often require special adapter fittings on the vehicles to complete the installation.

These and further problems with the prior art are that current PTFE fittings were not designed for installation where rubber hose and fittings were originally used, thus requiring a stack of multiple adapter fittings be used in combination to end up with the proper attachment threads and sizing.

### SUMMARY

A fluid fitting apparatus for coupling a PTFE hose to another fluid component includes a one-piece body having a first end carrying a first barb for sealing engagement with a PTFE hose and an opposed second threaded end.

The threaded end can be one of the external threads or internal threads.

The first barb includes a conical surface tapering with increased diameter from a first end of the body to an outer diameter edge. The outer diameter edge of the first barb can be a radius edge.

The second barb longitudinally spaced from the at least barb.

The second barb includes conical surface tapering with an increase diameter from a first end adjacent a cylindrical portion of the body to an outer diameter edge.

The fluid apparatus can include a separate clamp mounted over the PTFE hose and the body adjacent the second barb on the body to exert a clamping force on the PTFE hose to the body.

The fluid fitting apparatus can include a gripping surface carried on the body intermediate the first and second ends of the body. The gripping surface can be hex external flats.

The fluid fitting apparatus includes a plurality of threads carried on the body between the gripping surface and the second end of the body. The plurality of threads includes one of external threads and internal threads.

The fluid fitting apparatus includes a wall of the PTFE hose sealingly coupled over the at least one barb on the body.

The fluid fitting apparatus can include a sealing member carried on the body adjacent the at least one barb for increased sealing engagement with the PTFE hose. The sealing member can be an O'ring.

The fluid fitting apparatus can include a radially extending wall carried on the body adjacent an end of the first barb defining a recess with the one end of the first barb for receiving the sealing member.

The present fitting system overcomes the above identified problems of the prior art, as well as others, by providing a barb hose end fitting that utilizes a profile that allows it to be installed into the end of a PTFE-core hose, then be optionally sealed with a clamp (worm gear, band or similar clamp) and features a type of threaded end that mates to the common thread pitches (NPT, AN, etc) and sizing used for hose assemblies.

Among other things, the design of the present fitting apparatus simplifies the upgrade to the safe and durable PTFE-core hose while providing a desperately needed safety factor for older vehicles using today's fuel.

While the novice do-it-yourself (DIY) user will find the present fitting apparatus desirable to cure their safety and durability concerns, for the professional, such as the “trained mechanic,” the fitting apparatus will simplify their servicing requirements and provide a safe solution for their customer vehicles

The present fitting apparatus barbed and threaded ends can be provided in a variety of sizes and shapes to fit commonly available PTFE-core hose and threaded attachments points, respectively, making it easy to upgrade from prior art hose and fitting assemblies.

### BRIEF DESCRIPTION OF THE DRAWING

The various features, advantages, and other uses of the present fitting apparatus will become more apparent by referring to the following detailed description and drawing in which:

FIGS. 1A and 1B are perspective views prior art fluid conduit fitting apparatus;

FIG. 2 is a perspective view of the present fitting apparatus, shown in an assembled position with a PTFE tube attached to the fitting.

FIG. 3 is a perspective view of the fitting shown in FIG. 2;

FIG. 4 is a longitudinal cross-sectional view of the fitting shown in FIG. 3;

FIG. 5 is a cross-section assembled view of the fitting apparatus and PTFE hose;

FIG. 6 is a perspective view of another aspect of the present fitting apparatus; and

FIG. 7 is an end perspective view of the fitting apparatus shown in FIG. 6.

### DETAILED DESCRIPTION

The present disclosure relates to the fluid systems, particularly, fluid systems utilizing tubular conduits, pipes or hoses which are singularly connected to fittings which themselves are coupled to fluid operative components, such as valves, pumps, conduits, etc.

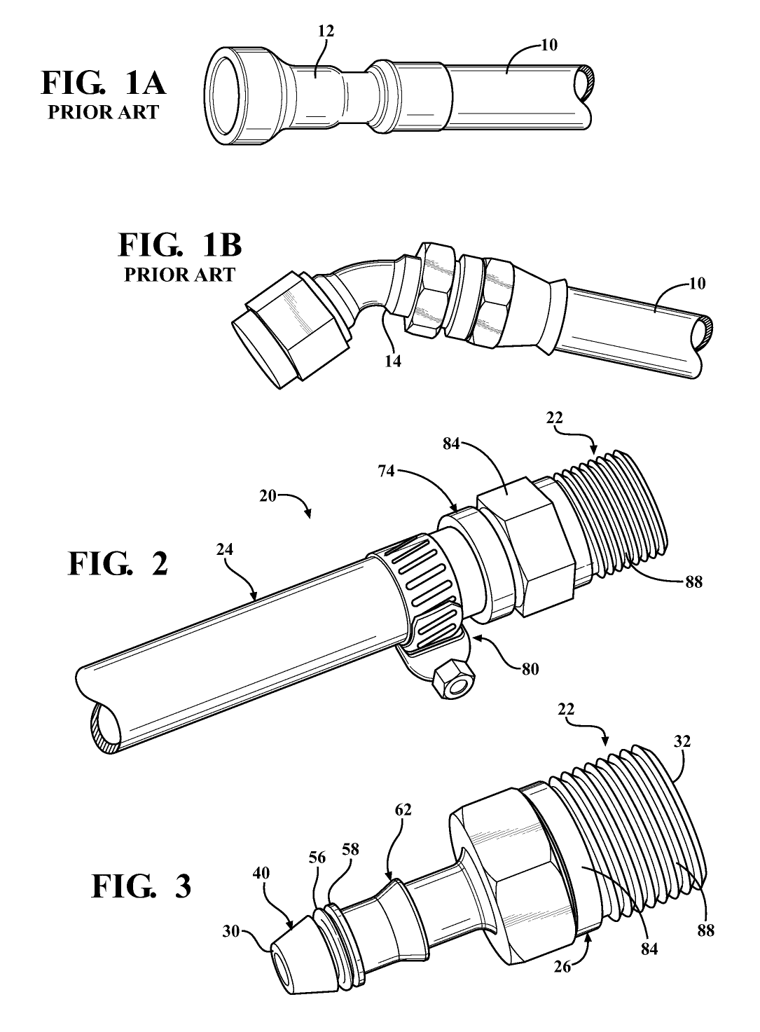

FIGS. 1A and 1B depict prior art fluid assemblies used to connect a tubular conduit, pipe or hose 10 via a fitting 12 or 14 to another conduit or fluid operative component, not shown. The fitting 12 is a tubular metallic member having one end which is crimped over the tube 10 and an opening at an opposed end which receives another conduit in a sealed connection.

The fitting 14 is similarly crimped at one end to the tube 10. The opposite end also has an opening for receiving another conduit in a sealed connection.

The present fitting apparatus 20 is depicted in FIGS. 2-7 for connection to a tubular conduit or hose, with a polytetrafluoroethylene (PTFE) hose 24, shown by example, to another fluid operative component, such as another conduit, a valve, a pump, etc.

The fitting apparatus includes a fitting 22 which has a one-piece body 26. The body 26 is formed of a material robust enough to withstand the rigors of automotive, farm, military, industrial, manufacturing or other high-wear uses. Such materials can include aluminum, brass, plastic, composite, steel, stainless or similar materials.

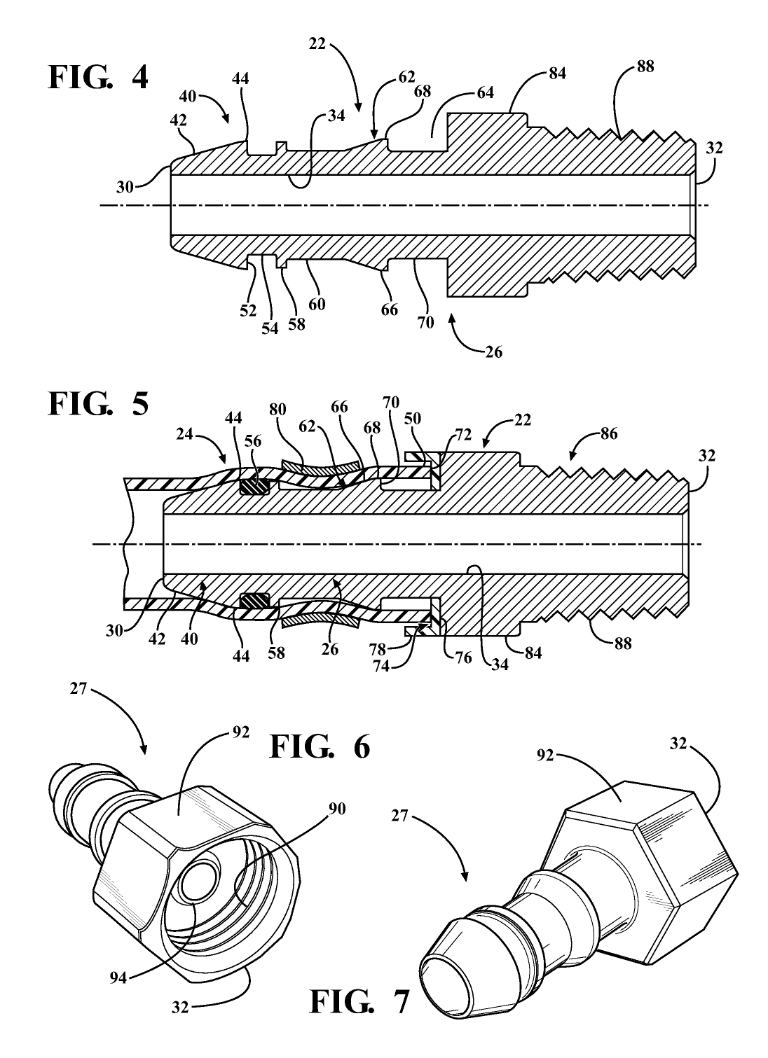

The body 26 has a first end 30 and an opposed second end 32. As shown in FIGS. 4 and 5, a through bore 34, of generally circular cross-section, extends between the first and second ends 30 and 32 in a linear path along the longitudinal centerline of the body 26.

It will be understood, as described hereafter, that the body 26 can take angular configurations, rather than a linear shape of the body 26 shown in FIGS. 2-7. The body 26 can take other angular shapes, such as shapes where the body 26 forms a 30°, 45°, 60° or 90° between the first and second ends 30 and 32. In such configurations, the through bore 34 will have a similar angular shape between first and second ends ends 30 and 32.

In order to sealingly couple a PTFE hose 24 on the body 26 of the fitting 22, the body 26 has an external profile extending from the first end 30 to an intermediate portion of the body 26 which allows an easy push-on connection of the open end of the PTFE hose 24, as shown in FIG. 5, onto the body 26.

The body 26 includes a first barb 40 extending from the first end 30. The first barb 40 has a conical increasing diameter smooth outer surface 42 extending from the first end 30 of the body 26 to an enlarged outer diameter edge 44. The outer diameter edge 44 has a rounded outer radius shape and forms a primary sealing surface for the PTFE hose 24. The smooth conical surface 42 forms a secondary sealing surface for the PTFE hose 24. The first end 30 of the body 26 has a diameter slightly smaller than the inner diameter of an outer wall of the PTFE hose 24. It allows the open end 50 of the PTFE hose 24, as shown in FIG. 5 to be pushed on to and over the first barb 40.

The first barb 40 transitions from the outer edge 44 into a shoulder or wall 52. The wall 52 terminates in an inner diameter portion 54 having a first diameter.

The inner diameter portion 56 as well as the wall 52 forms a sealing ring or O-ring 58 in seat conjunction with a radial perpendicularly extending wall 58 projecting from the inner diameter 54. The walls 52 and 58 and the inner diameter 54 form a circular recess for retaining the O-ring 58 in a snap in position on the body 26.

The wall 58 transitions into a second, diameter portion 60 on the body 26. By example, the second inner diameter portion 60 has a larger inner diameter than the first diameter portion 64.

A second barb 62 is formed on the body 26 between the second diameter portion 60 and a third cylindrical inner diameter portion 64. The second barb 62 is similar to the first barb 40 and includes a smooth, conical, radially outward extending surface 66 extending from the second diameter portion 62 to a radially outermost edge 68. The second barb 62 transitions in a perpendicular wall 70 extending between the outermost edge 68 and the third inner diameter portion 64 of the body 26.

As shown in FIG. 5, the open end 50 of the PTFE hose 24 can be forcibly urged over the first barb 40. This causes the inner diameter of the PTFE hose 24 to expand slightly and slide radially outward over the outermost edge 44 of the first barb 40, the O-ring 58, the second wall 58, and the outermost edge 68 of the second barb 62. The end 50 of the PTFE hose 24 can abut or be disposed in a close proximity to a radially extending angular wall 70 formed on the body 26.

An optional cover member 74 in the form of an expandable, flexible member made of a suitable polymer or rubber, can be slid over the first end portion of the body 26 into the third inner diameter portion 64 abutting the wall 70. The cover member 74 can be in the form of a collar or washer having a generally cylindrical shape with an end wall 76 with a central aperture of a diameter enabling the member 74 to be urged over the first and second barbs 40 and 62. The cover member 64 includes an outer lip 78 extending perpendicularly from the wall 76.

The cover member 74 covers the open end of the PTFE hose 24 for a closed appearance to the fitting apparatus 20.

As shown in FIGS. 1 and 5, an optional clamp 80, which can be in the form of a worm gear, threaded band or similar clamp structure, is mounted over the PTFE hose 24 generally in a location between the wall 58 and the conical surface 56 of the second barb 62 to seal and tightly secure the PTFE hose 24 to the fitting 22.

It will be understood that certain applications of the fitting apparatus 22 may not require the clamp 80.

The wall 72 forms one end of an intermediate gripping surface on the body 26 of the fitting 22. The gripping surface 84 can be in the form of hex flats or other non-circular shape to provide a gripping area to enable the body 26 to be threaded into another component. For purpose, a second end portion 86 of the body 26 extending from the second end 32 to the gripping surface 84 is formed with threads 88 for a threading connection to another fluid operative component. The threaded end of the body 26 can be formed with threads to mate with common thread pitches (NPTAN), etc. and various diameter sizes.

In FIGS. 4 and 5, the threads 88 are depicted, by example, as external threads. FIGS. 6 and 7 depict a similar fitting body 26 with threads 90 shown as internal threads in an elongated hex or gripping portion 92 extending completely to the second end 32 of the fitting body 26.

FIG. 6 also depicts an inverted flare surface 94 within the gripping portion 92 of the fitting body 26. The inverted flare surface 94 acts as a sealing surface between the fitting body 22 and the threadingly attached component.

Thus, there has been disclosed a unique barbed hose end fitting apparatus 20 for coupling a polytetrafluoroethylene (PTFE) core hose to another fluid component. The fitting apparatus 20 includes one or more tapered barbs 40 and 62 which are sized and shaped to seal with the inner wall of PTFE core hose 26. The barbs 40 and 62 are shaped to provide a sealing connection between the fitting apparatus 20 and the inner wall of the PTFE hose 24, but still enable the hose 24 to be coupled to the fitting body 26 with or without special insertion tools.

The tapered barbs 40 and 62 and outer edge shapes feature a sealing surface at the tips or outer edges 44 and 68 to maximize sealing pressure while maintaining the viability of the PTFE core hose 24 wall thickness throughout the life cycle of the hose assembly.

A sealing member or O-ring, which may be formed of a combustible fuel resistant material, may be optionally installed in specific fitting situations to improve the sealing capabilities of the barb shapes to the inner diameter wall of a PTFE hose.

A threaded end of the fitting body 26 can be provided in common thread sizes to allow the fitting body 26 to be easily coupled to commonly sized and threaded openings in components, such as fuel pumps, carburetors, fuel tanks, fuel filters, water pumps, transmission cooler lines, coolant lines and other common liquid transfer system components.

Alternately, the threaded end can be replaced with a quick connect end to allow flexibility during installing of the fitting assembly.

What is claimed:

1. A fluid fitting apparatus for coupling PTFE hose to a fluid component comprising:
a one piece body having a first end carrying a first barb for sealing engagement with a PTFE hose and an opposed second threaded end.

2. The fluid fitting apparatus of claim 1 wherein:
the second threaded end includes one of external threads and internal threads.

3. The fluid fitting apparatus of claim 1 wherein the first barb comprises:
a conical surface tapering with increased diameter from a first end of the body to an outer diameter edge.

4. The fluid fitting apparatus of claim 3 wherein:
the outer diameter edge of the first barb is a radius edge.

5. The fluid fitting apparatus of claim 1 further comprises:
a second barb longitudinally spaced from the first barb on the body.

6. The fluid fitting apparatus of claim 5 wherein the second barb comprises:
a conical surface tapering with an increase diameter from a first end adjacent a cylindrical portion of the body to an outer diameter edge.

7. The fluid fitting apparatus of claim 5 further comprising:
a clamp mounted over the PTFE hose and the body adjacent the second barb on the body to exert a clamping force on the PTFE hose to the body.

8. The fluid fitting apparatus of claim 1 further comprising:
a gripping surface carried on the body intermediate the first and second ends of the body.

9. The fluid fitting apparatus of claim 8 wherein the gripping surface comprises:
hex external flats.

10. The fluid fitting apparatus of claim 8 further comprising:
a plurality of threads carried on the body between the gripping surface and the second end of the body.

11. The fluid fitting apparatus of claim 10 further comprising:
the plurality of threads include one of external threads and internal threads.

12. The fluid fitting apparatus of claim 1 further comprising:
a wall of the PTFE hose sealingly coupled to the first barb on the body.

13. The fluid fitting apparatus of claim 1 further comprising:
a sealing member carried on the body adjacent the at least one barb for increased sealing engagement with the PTFE hose.

14. The fluid fitting apparatus of claim 13 wherein the sealing member comprises:
an O-ring.

15. The fluid fitting apparatus of claim 13 further comprising:
a radially extending wall carried on the body spaced from an end of the first barb and defining a recess with the end of the first barb for receiving the sealing member.
